(19) United States
(12) Patent Application Publication
(10) Pub. No.: US 2010/0323163 A1
(43) Pub. Date: Dec. 23, 2010

(54) SEED CRYSTAL COATING FOR GYPSUM WALLBOARD FACING

(75) Inventors: Wilfried Adolf HOHN, Erftstadt (DE); Alexander Adolphe KINDLER, Ratingen (DE); Joachim KRAUSE, Remscheid (DE); Christian MORGENROTH, Essen (DE); Brigitte RENNERT, Neuss (DE)

Correspondence Address: HERCULES INCORPORATED;HERCULES PLAZA, 1313 NORTH MARKET STREET, WILMINGTON, DE, 19894-0001, US

(73) Assignee: HERCULES INCORPORATED, Wilmington, DE (US)

(21) Appl. No.: 12/819,263

(22) Filed: Jun. 21, 2010

Related U.S. Application Data
(60) Provisional application No. 61/219,102, filed on Jun. 22, 2009.

(51) Int. Cl. B32B 13/08; E04C 2/04; B32B 7/04; B05C 9/06

(52) U.S. Cl. 428/148; 427/283; 428/703; 156/283

(57) ABSTRACT

Facing material useful in the manufacture of gypsum wallboard is surfaced treated in order to adhere an amount of seed crystals to improve the adhering affinity of the facing material for wet plaster thereby permitting the manufacture of gypsum wallboard with little or no added starch and reduced amounts of water. Various means for adhering the seed crystals to the facing material are described as well as, a method of converting the facing material and wallboards containing the facing material are also described.

### RELATED APPLICATIONS

This application claims the benefit of U.S. Provisional Application Ser. No. 61/219,102, filed on Jun. 22, 2009, the disclosure of which is incorporated herein by reference in its entirety.

### FIELD OF THE INVENTION

The present invention relates to a seed crystal coating useful as an additive in the manufacture of gypsum wallboard that permits the manufacture of wallboards with little or no starch binder. The present invention also relates to facing material treated with the additive as well as to a process for manufacturing gypsum wallboard that significantly reduces the quantity of drying energy required as compared to prior art processes. More specifically, the present invention relates to a process for making the facing material component of gypsum wallboard with an improved bonding affinity for wet plaster.

### BACKGROUND OF THE INVENTION

The gypsum wallboard industry produces wallboard through a process designed to ensure an effective adhesive bond between two external layers of a facing material, typically heavy caliper paper, that enclose an interior gypsum plaster core. The industry traditionally has added large quantities of starch binder to the plaster core in order to promote adhesion to the facing material. The industry also adds a large excess of water to the plaster so that, during drying of the plaster between the two facing material layers, the excess water can migrate from the wet plaster into the facing material carrying starch binder along with it to establish bonding of the plaster to the facing material surface. However, such a process is highly energy-intensive due to the amount of drying energy required to migrate and evaporate the excess water from the gypsum plaster core.

There is general industry need for reducing the amount of water used in the production of wallboard since drying costs have increased substantially for the gypsum wallboard producers. It is also apparent that a reduced plaster to water ratio can be attainable with the present invention that can in turn result in a higher strength wallboard. The strength can also be improved by the application of the seed crystal coating on the facing layers by improving the paper strength, which has a mayor influence on the total wallboard strength.

It has unexpectedly found that an alternative to the use of starch and high water ratio in the wet plaster core can be practiced and yet still achieve strong bond between the facing material layers and the plaster core.

### SUMMARY OF THE INVENTION

The present invention relates to a process for making gypsum wallboard by applying a surface treatment comprising a seed crystal coating to a facing material layer of the wallboard prior to contacting the facing material layer with wet plaster to enhance the plaster bond to the facing material layer. The plaster component can then employ a relatively low amount of water and yet still form a strong bond to this substrate.

The present invention also relates to a seed crystal coating composition useful as an additive in the manufacture of gypsum wallboard that permits the manufacture of wallboards with little or no starch binder. The present invention also relates to facing material layer treated with the seed crystal coating.

Additionally, the present invention relates to a wallboard having an interior gypsum plaster core, and at least one treated facing material layer adhered to a surface of the interior gypsum plaster core wherein the facing material layer has a surface treated with a seed crystal coating. The surface of the interior gypsum plaster core is adhered to the surface of the facing material layer treated with the seed crystal coating.

The treated facing material for use in wallboard contains a facing material layer upon which a layer of seed crystals is adhered. This facing material may be generally known as “paper,” but with more particularity be selected from the group consisting of papers, glass fiber sheets and synthetic sheet materials.

The facing material is treated in such a manner with an adhering agent to adhere the seed crystals to a surface of the facing material. This treatment may comprise first contacting the surface of the facing material with an amount of water in order to wet the surface of the facing material and subsequently applying the seed crystals as a powder to the moistened facing material surface. Alternatively, the seed crystals may be dissolved or suspended into a liquid, such as water and applied to the surface of the facing material and this moistening facing material surface is subsequently permitted to dry. Alternatively, the adhering agent may comprise a surface treatment adhesive. The surface treatment adhesive may be any adhesive, such as for example a solvent-based, aqueous-based or solventless adhesive, which permits adherence of the seed crystals to the surface of the facing material in order to form the seed crystal coating. Preferably, the surface treatment adhesive comprises water and a latex binder, which may be applied to the facing material surface and subsequently upon applying the seed crystals as a powder to the moistened facing material surface form the seed crystal coating. The surface treatment adhesive may also contain the seed crystals, a rheology modifier, such as cellulose ether or a biopolymer or mixtures thereof.

Prior to this invention, the use of high levels of starch and water in gypsum wallboard has been required in order to assure proper bond of the gypsum to the facing material component.

This invention has advantages in allowing a reduction in the water/plaster ratio and hence can provide a reduced energy requirement to make wallboard, of wallboard through use of lower water/plaster ratio. The invention thus represents a process to permit the production of wallboard with improved properties.

### DETAILED DESCRIPTION OF THE INVENTION

It was unexpectedly found that a facing material layer of gypsum wallboard can be surface treated with a seed crystal coating so as to enhance the bonding tendency of the wallboard's plaster inner core to the facing material. This enhanced bonding tendency or affinity in turn allows a plaster core to be formulated with lower water and starch content, which reduces the amount of energy needed to dry the wallboard. Among the advantages of reducing or eliminating the starch content of the plaster core of a wallboard is that the resultant wallboard is potentially less susceptible to microbial attack when exposed to high humidity or other favorable environmental conditions which promote microbial growth.

The present invention relates to a surface treatment of a facing material layer useful in producing a gypsum wallboard wherein an amount of a seed crystal is adhered to a surface of the facing material to produce a seed crystal coating surface treated facing material. The seed crystals can then be available for subsequent crystal growth when brought in contact with wet plaster in the production of gypsum wallboard thereby increasing the adhesion between the gypsum core of the wallboard and the facing material layer.

The preferred seed crystals of use in the present invention may be selected from the group consisting of:

| | |
|---|---|
| Calcite, | CaCO₃ |
| Barite, | BaSO₄ |
| Glauber's salt, | Na₂SO₄ |
| Alaune, Potassiumaluminiumsulfate, | KAl(SO₄)₂ × 12 H₂O |
| Dolomite, | CaMg(CO₃)₂ |
| Magnesite, | MgCO₃ |
| Potassium sulfate, | K₂SO₄ |
| Iron sulfate, | Fe₂[SO₄]₃/FeSO₄ |
| Aluminum sulfate, | Al₂[SO₄]₃ |

and their different crystal water containing derivatives.

The more preferred seed crystals of use in the present invention may be selected from the group consisting of:

| | | |
|---|---|---|
| Gypsum Anhydrite | CaSO₄ | [Anhydrite] |
| Gypsum Hemihydrate | CaSO₄ × ½ H₂O | [Hemihydrate] |
| Gypsum Dihydrate | CaSO₄ × 2 H₂O | [Dihydrate] |

An adhering agent is employed as a surface treatment of the facing material of wallboard to adhere the seed crystals to the facing material. This treatment may comprise first contacting the surface of the facing material with an amount of water in order to wet the surface of the facing material and subsequently applying the seed crystals as a powder to the moistened facing material surface. Alternatively, the seed crystals may be dissolved or suspended into a liquid, such as water and applied to the surface of the facing material and this moistening facing material surface is subsequently permitted to dry. Alternatively, the adhering agent may comprise a surface treatment adhesive. The surface treatment adhesive may be any adhesive, such as for example a solvent-based, aqueous-based or solventless adhesive, which permits adherence of the seed crystals to the surface of the facing material in order to form the seed crystal coating. Preferably the surface treatment adhesive comprises water and a latex binder, which may be applied to the facing material surface and subsequently upon applying the seed crystals as a powder to the moistened facing material surface form the seed crystal coating. The surface treatment adhesive may also contain the seed crystals, a rheology modifier, such as cellulose ether or a biopolymer or mixtures thereof.

The surface treatment adhesive may also optionally contain such additional ingredients as rheology modifiers, stabilizers and preservatives.

When the surface treating adhesive comprises a latex adhesive, the latex binder component of the surface treatment adhesive is preferred to be in the range of about 0.5-55 wt % of the surface treatment adhesive. The latex binder component of the surface treatment adhesive may be selected from commonly available latex polymers and may be selected from the group consisting of ethylene vinyl acetate co-polymer, poly(vinyl acetate) (PVOAc)latex, styrene butadiene rubber (SBR), acrylic-based polymers, vinyl acrylic-based polymers. Preferably, the latex binder component is ethylene vinyl acetate co-polymer or poly(vinyl acetate) (PVOAc)latex. One form in which the latex adhesive may be used in the present invention is as a redispersible powder.

Other water-soluble species selected from the group consisting of rheology modifiers, salts, accelerators and dispersants may be used as additives in surface treatment adhesive to affect other properties of the treated facing material and the resultant wallboard. The preferred rheology modifier comprises cellulose ethers. The cellulose ethers of use in the present invention may be selected from the group consisting of carboxymethylcellulose(CMC), hydroxypropylmethylcellulose(HPMC), methylhydroxyethylcellulose (MHEC), methylcellulose(MC), hydroxypropylcellulose(HPC), hydrophobically modified hydroxypropylcellulose(HMHPC), hydroxyethylcellulose(HEC), ethyl hydroxyethylcellulose(EHEC), hydrophobically modified hydroxyethylcellulose(HMHEC), cationic hydrophobically modified hydroxyethylcellulose(cationic HMHEC), and anionic hydrophobically modified hydroxyethylcellulose(anionic HMHEC).

The rheology modifier may also comprise biopolymers. The preferred biopolymers comprise xanthan gum, welan gum or diutan gum.

One aspect of the invention is that surface treatment adhesive, when it contains the seed crystal material as well as the rheology modifier, results in fluid mixtures having high levels of seed crystal. A high level of seed crystal is a level of seed crystal about 2% by weight or more, preferably about 10% by weight of the surface treatment adhesive. Preferred rheology modifiers are xanthan, welan or diutan gum.

In practice, the adhering agent is applied to a surface of the facing material by any of the mechanical processes typically used in the art of paper conversion, including, but not limited to, using a doctor blade, using a roll, using a puddle applicator, using a size press, using a curtain coater, using a water box, or using of a spray applicator. The adhering agent is applied to one or both interior surfaces of facing material employed in wallboard manufacture producing a facing material with a surface-treated side which is capable of adhering the seed crystals to the facing material to produce the seed crystal coating. In cases where the adhering agent is not consisting of water, the amount of adhering agent used to treat the paper is of a level of greater than about 0.1 gm/m², preferably in the range of greater than about 0.1 gm/m² to 20 gm/m², preferably about 0.5 to 4 gm/m², more preferably about 1 to 3 gm/m², still more preferably in the range of about 1.5 to 2.5 gm/m² (based on solids after drying (without water)). By applying the adhering agent as a coating in this range, the adhering agent promotes an adhesion of the seed crystals to the facing material layers which in turn increases the adherence of the facing material layers to the plaster inner core of the wallboard in the case where the plaster either contains no starch at all or a reduced quantity of starch compared to standard practice.

Facing material of use in the present invention may be selected from the group consisting of papers, glass fiber and synthetic materials. The papers may coated, waxed or uncoated.

The facing material may in the form of a nonwoven or woven material, or in the form of a fabric, scrim, film, sheet or foil.

Where the facing material is a synthetic materials may be selected from the group consisting of polyethylene, polypropylene, polyvinylchloride, polyurethane and epoxy.

Where the facing material is glass fiber material, these materials may include (1) a mineral-type material such as glass fibers. The mat can comprise continuous or discrete strands or fibers and can be woven or nonwoven in form. Facing material may comprise nonwoven mats such as made from chopped strands and continuous strands can be used satisfactorily and are less costly than woven materials. The strands of such mats typically are bonded together to form a unitary structure by a suitable adhesive. The nonwoven fiber mat can range in thickness, for example, from about 10 to about 40 mils.

In cases where the facing material has a desired level of porosity, such as certain papers and other non-woven materials, as well as certain woven fabrics and the like, it is preferred that the adhering agent and the ultimate seed crystal coating have minimal effects on the porosity of the facing material when producing a facing material with a seed crystal coating side. This preservation of the facing material porosity is of utility in the production of wallboard since after wet plaster is applied to the treated surface of the facing material with a seed crystal coating side, water found at this surface may readily evaporate through the facing material layers. The porosity property of facing material can be measured by means of a standard test method termed “Gurley porosity” involving Hagerty Porosimeter apparatus at a “low” setting.

If a one step continuous process is desired, the adhering agent and the seed crystal may be applied to the surface of the facing material and wet plaster is then applied to the facing material with a seed crystal coated side.

The facing material with a seed crystal coated side is converted into a wallboard by a mechanical process whereby one or both sides of a layer of wet plaster are brought into contact with seed crystal coated surface of the facing material with a seed crystal coated side to create a wallboard composition useful in construction applications. The wet plaster in the present invention case preferably contains either no starch or a reduced quantity of starch compared to the prior art. The wet plaster may also generally contain a reduced level of water compared to standard wallboard plaster preparations. Therefore by replacing all or a proportion of the starch component of the final wallboard composition with the facing material with a seed crystal coated side of the facing material of the present invention, a novel wallboard composition is created.

In the process of producing wallboard, a two-step process is envisioned where the facing material with a seed crystal coated side of the present invention which has been previously produced is subsequently combined with a layer of wet plaster to produce a wallboard. Alternatively, a one step process is also envisioned where the seed crystal coating is applied to the facing material surface and, prior to completely drying the facing material, wet plaster is applied to the facing material with a seed crystal coated side to produce a wallboard.

The invention is further demonstrated by the following examples. The examples are presented to illustrate the invention, parts and percentages being by weight, unless otherwise indicated.

### EXAMPLES

### Example 1

First, the facing material comprising a typical industrial gypsum wallboard paper was cut to the size of 200×300 mm. Then the paper was coated via airless spraying with approximately 1 g/m² in a vertical position using a 5% by weight latex dispersion of a redispersible powder in tap water. Immediately after spraying, the seed crystal, gypsum dihydrate, was dusted on the wet paper surface.

After drying at ambient conditions for 24 hours, the paper containing the seed crystal surface-treated side was used to make test specimen using the following procedure:
Alabaster Model gypsum was mixed with 55% by weight water by hand;
This slurry was filled into a test ring which was lying on one side of the prepared paper and covered with a second sheet after the filling;
The test specimen was pressed together until the gypsum setting started; and
After 24 hours of drying at 40° C., the paper was pulled off and the adhesion was judged.

Compared with test specimen without starch, this procedure provides a fair improvement, as set forth in Table 1.

### Example 2

First, the facing material comprising a typical industrial gypsum wallboard paper was cut to the size of 200×300 mm. Then the paper was soaked, by hand, into tap water for approximately 5 minutes and subsequently the seed crystal, gypsum hemihydrate, was strewed on the wet paper surface.

After drying at ambient conditions for 24 hours, the seed crystals which did not adequately adhere were removed from the paper surface. Then the test specimen was produced and tested using the procedure described in Example 1.

Compared with other tests, the paper containing the seed crystal surface-treated side showed very good adhesion to the gypsum core, as set forth in Table 1.

### Example 3

First, the facing material comprising a typical industrial gypsum wallboard paper was cut to the size of 200×300 mm. Then the paper was soaked, by hand, into an aqueous suspension of calcium sulfate dihydrate for approximately 5 minutes.

After drying at ambient conditions for 24 hours, the seed crystals which did not adequately adhere were removed from the paper surface. Then the test specimen was produced and tested using the procedure described in Example 1.

Compared with test specimen without starch the adhesion between paper and gypsum core was fair, as set forth in Table 1.

### Example 4

First, the facing material comprising a typical industrial gypsum wallboard paper was cut to the size of 200×300 mm. Then the paper was spray coated with an aqueous suspension of 10% Aquapas™ N2090 redispersible vinyl acetate-ethylene copolymer polymer powder (available from Ashland Inc.) in tap water. Papers were coated with 1.75 and 5% by weight latex, on dry basis.

After drying at ambient conditions for 24 hours, test specimen were produced and tested using the procedure described in Example 1.

In comparison to test specimen without starch the resulting adhesion between facing material and gypsum core was good, as set forth in Table 1.

TABLE 1
Overview of test results

| | Reference - untreated | Example 1 - spraying | Example 2 - soaking | Example 3 - soaking | Example 4 - |
|---|---|---|---|---|---|
| | paper and gypsum | and dusting of | in water and strewing | in dihydrate | spraying |
| | without starch | dihydrate | with hemihydrate | solution | of latex |
| Adhesion Rating | * | ** | **** | ** | *** |

The adhesion of the facing material was rated using the following ranking system:
* = poor
** = fair
*** = good
**** = very good
***** = excellent

### Example 5

First the facing material comprising a typical industrial gypsum wallboard paper was cut to the size of 200×200 mm and weighed with an accuracy of 0.01 g. 10 g of a dry mixture containing 82% calcium sulfate dihydrate, 17.5% Aquapas™ N 2090 redispersible vinyl acetate-ethylene copolymer polymer powder (available from Ashland Inc.) and 0.5% Supercol® XG 80 xanthan gum (available from Ashland Inc.) were added to 90 g of tab water. The mixture was stirred with a magnet stirrer for 20 minutes. Afterwards, the paper was coated (in a vertical position) with 20.0 g of the prepared dispersion per m² using airless spraying.

The paper was re-weighed with 0.01 g accuracy to check, if the correct amount was applied (2.0 g solids per m²). After drying at ambient conditions for 24 hours, the facing material having the seed crystal coating was used to make gypsum boards. Test boards were produced according to the following procedure:
30 g foam solution (0.01% air-entraining agent (AEA), Ammonium salt of lauryl polyether sulfate) was used to prepare foam by using a hand mixer, mixing for 90 seconds;
600 g gypsum are used to prepare a slurry with 55% by weight water, taking the foam water into account;
mix with IKA® Werke GmbH & Co. KG magnetic stirrer for 15 seconds;
add foam to the gypsum slurry;
mix with IKA® Werke GmbH & Co. KG magnetic stirrer for 15 seconds to get a homogeneously foamed slurry;
put paper containing the seed crystal coating side into a form with the seed crystal coating side up, add gypsum slurry (thickness of board: ˜10 mm);
cover form containing the gypsum slurry with a second layer of facing material having the seed crystal coating;
remove form after setting of the gypsum core;
15-30 minutes maturing time at ambient conditions; and
drying in cabinet dryer to dry the board to constant weight.

### Test Procedure for Adhesion Test:

To test the adhesion between the cover and the dried gypsum board, a cross cut was made into the facing material of the board. Afterwards, the facing material was pulled off by hand and the area of remaining facing material on the gypsum core was visually rated.

Compared with gypsum boards without starch, the gypsum board of Example 5 demonstrated a noticeable improvement.

### Example 6

First, the facing material comprising a typical industrial gypsum wallboard paper was cut to the size of 50×145 mm and weighed with an accuracy of 0.01 g. 10 g of a dry mixture containing 82% by weight seed crystal, 17.5% by weight Aquapas™ N 2090 redispersible vinyl acetate-ethylene copolymer polymer powder (available from Ashland Inc.) and 0.5% by weight Supercol® XG 80 xanthan gum (available from Ashland Inc.) were added to 90 g of tap water. The mixture was stirred with a magnet stirrer for 20 minutes. Afterwards, the paper was coated (in a vertical position) with 20.0 g of the prepared dispersion per m² using airless spraying.

Seed crystals used are:
Calcium carbonate (Fluka 21060)
Sodium sulfate (Riedel de Haen 13464)
Iron-II-Sulfate (Riedel des Haen 12353)
Aluminiumsulfate-Hydrate (Riedel de Haen 11046)
Barium sulfate (AppliChem A4911; 1000)
Potassiumaluminiumsulfate (AppliChem A4396, 1000)
Magnesium carbonate (Sigma 63062)
Potassium sulfate (Kraft 06170.3600)
Dolomite (90 μm, Dolomitwerk Jettenberg)

The paper was re-weighed with 0.01 g accuracy to check, if the correct amount was applied (about 2.0 g solids per m²). After drying at ambient conditions for 24 hours, the facing material having the seed crystal coating was used to make gypsum boards. Test boards were produced according to the following procedure:
200 g gypsum are used to prepare a slurry with 55% by weight water,
mix with Handmixer for 15 seconds;
mix with IKA stirrer for 15 seconds to get a homogeneously slurry;
put paper containing the seed crystal coating side into a form with the seed crystal coating side up, add gypsum slurry (thickness of board: ˜10 mm);
cover form containing the gypsum slurry with a second layer of facing material having the seed crystal coating;
15-30 minutes maturing time at ambient conditions; and
drying in cabinet dryer to dry the board to constant weight.

### Example 7

First, the facing material was cut to the size of 50×145 mm and weighed with an accuracy of 0.01 g. 10 g of a dry mixture containing 82% by weight calcium sulfate dihydrate, 17.5% by weight Aquapas™ N 2090 redispersible vinyl acetate—ethylene copolymer polymer powder (available from Ashland Inc.) and 0.5% by weight Supercol® XG 80 xanthan gum (available from Ashland Inc.) were added to 90 g of tap water. The mixture was stirred with a magnet stirrer for 20 minutes. Afterwards, the facing material was coated (in a vertical position) with 20.0 g of the prepared dispersion per m² using airless spraying.

Facing Materials used are:
Fiberglass sheet
Aluminum foil
Foamed rubber
Cotton, woven fabric, 210 g/m²
Silk, woven fabric, Pongé 08
Polyethylene foil

The facing material was re-weighed with 0.01 g accuracy to check, if the correct amount was applied (2.0 g solids per m²). After drying at ambient conditions for 24 hours, the facing material having the seed crystal coating was used to make gypsum boards. Test boards were produced according to the following procedure:
200 g gypsum are used to prepare a slurry with 55% by weight water,
mix with Handmixer for 15 seconds;
mix with IKA stirrer for 15 seconds to get a homogeneously slurry;
put paper containing the seed crystal coating side into a form with the seed crystal coating side up, add gypsum slurry (thickness of board: ˜10 mm);
cover form containing the gypsum slurry with a second layer of facing material having the seed crystal coating;
15-30 minutes maturing time at ambient conditions; and
drying in cabinet dryer to dry the board to constant weight.

### Example 8

First, the facing material comprising a typical industrial gypsum wallboard paper was cut to the size of 50×145 mm and weighed with an accuracy of 0.01 g. The paper was coated with a roll on technique with the adhesive. Exception is the spray adhesive which was spray applied to the paper. Then calcium sulfate dihydrate was applied on top of the adhesive.

Adhesives used are:
10% solution of methylhydroxypropylcellulose (MHPC)
Aerosol Spray adhesive, solvent based (UHU Sprühkleber available from UHU Alleskleber)
10% solution of polyvinylalcohol

The paper was re-weighed with 0.01 g accuracy to check, if the correct amount was applied (˜2.0 g solids per m²). After drying at ambient conditions for 24 hours, the facing material having the seed crystal coating was used to make gypsum boards. Test boards were produced according to the following procedure:
200 g gypsum are used to prepare a slurry with 55% by weight water,
mix with Handmixer for 15 seconds;
mix with IKA stirrer for 15 seconds to get a homogeneously slurry;
put paper containing the seed crystal coating side into a form with the seed crystal coating side up, add gypsum slurry (thickness of board: ˜10 mm);
cover form containing the gypsum slurry with a second layer of facing material having the seed crystal coating;
15-30 minutes maturing time at ambient conditions; and
drying in cabinet dryer to dry the board to constant weight.

### Test Procedure for Adhesion Test in Example 6-8:

To test the adhesion of the cover on the dried gypsum board, the facing material of the board was connected to an automated strengths controlled pull of machine, texture analyzer TA.XTplus. The required force to pull of the facing material was measured. The Texture Analyser was placed in a vertical position. A screw clamp was fixed in the instrument arms. The screw clamp was moved nearby to the TA table for zero point adjustment. A lifting table was set directly on the TA table on which the ring with core and cover sheet (5×14.5 cm) was placed.
The upside cover was fixed in the screw clamp. The texture analyzer used TA.XTplus software was “Verklebung von Tabakblättern” with the following changes: measuring distance from 10 cm to 20 cm, measurement speed was 10 mm/min. The adhesion was measured as the maximal force in Newton [N] value during the first 90 sec.

Compared with gypsum boards without starch, the gypsum boards of Examples 6-8 demonstrated noticeable improvements. A noticeable improvement is an increase in adhesion of greater than 100% compared to the no starch reference.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

What is claimed:

1. A treated facing material for use in gypsum wallboards comprising:
a facing material wherein a surface of the facing material is treated with an amount of a seed crystal adhered to the surface of the facing material wherein the seed crystal is selected from the group consisting of CaCO₃, CaSO₄, BaSO₄, Na₂SO₄, KAl(SO₄)₂, CaMg(CO₃)₂, MgCO₃, K₂SO₄, Fe[SO₄]₃/FeSO₄, Al₂[SO₄]₃, and their hydrate forms.

2. The treated facing material for use in gypsum wallboards of claim 1 wherein the seed crystal comprises CaSO₄ and its hydrate forms.

3. The treated facing material for use in gypsum wallboards of claim 2 wherein the CaSO₄ is in its anhydrite form.

4. The treated facing material for use in gypsum wallboards of claim 2 wherein the CaSO₄ is in its hemihydrate form.

5. The treated facing material for use in gypsum wallboards of claim 2 wherein the CaSO₄ is in its dihydrate form.

6. The treated facing material for use in gypsum wallboards of claim 1 wherein the facing material is selected from the group consisting of papers, glass fiber sheets and synthetic sheet materials.

7. The treated facing material for use in gypsum wallboards of claim 6 wherein the synthetic sheet materials may be selected from the group consisting of polyethylene, polypropylene, polyvinylchloride, polyurethane and epoxy.

8. A process for producing a treated facing material for use in gypsum wallboards comprising the steps of:
a) obtaining a facing material;
b) obtaining an amount of a seed crystal; and
c) adhering the seed crystal to at least one surface of the facing material to obtain a surface of the facing material with a seed crystal coating, wherein the seed crystal is selected from the group consisting of CaCO₃, CaSO₄, BaSO₄, Na₂SO₄, KAl(SO₄)₂, CaMg(CO₃)₂, MgCO₃, K₂SO₄, Fe[SO₄]₃/FeSO₄, Al₂[SO₄]₃, and their hydrate forms.

9. The process for producing the treated facing material for use in gypsum wallboards of claim 8 wherein the adhering of the seed crystal is accomplished through the steps of:
i obtaining an amount of an adhering agent;
ii applying the adhering agent to the at least one surface of the facing material; and
iii subsequently applying the seed crystal to the at least one surface of the facing material to obtain the surface of the facing material with the seed crystal coating.

10. The process for producing the treated facing material for use in gypsum wallboards of claim 9 wherein the adhering agent is water.

11. The process for producing the treated facing material for use in gypsum wallboards of claim 9 wherein the adhering agent is an adhesive.

12. The process for producing the treated facing material for use in gypsum wallboards of claim 11 wherein the adhesive is selected from the group consisting of solvent-based, aqueous-based or solventless adhesives.

13. The process for producing the treated facing material for use in gypsum wallboards of claim 12 wherein the adhesive comprises a latex adhesive.

14. The process for producing the treated facing material for use in gypsum wallboards of claim 13 wherein the latex adhesive is in the form of a redispersible powder.

15. The process for producing the treated facing material for use in gypsum wallboards of claim 8 wherein the adhering agent is applied to the at least one surface of the facing material by an application means selected from the group consisting of a doctor blade, a roll, a puddle applicator, a size press, a curtain coater, a water box, and a spray applicator.

16. The process for producing the treated facing material for use in gypsum wallboards of claim 8 wherein the adhering of the seed crystal is accomplished through the steps of:
i obtaining a facing material capable of absorbing water;
ii applying an amount of water as the adhering agent to the at least one surface of the facing material; and
iii subsequently applying the seed crystal to the at least one surface of the facing material to obtain the surface of the facing material with the seed crystal coating.

17. The process for producing the treat facing material for use in gypsum wallboards of claim 8, further comprising using paper as the facing material for use in gypsum wallboards wherein the adhering of the seed crystal is accomplished during a paper production process through applying the seed crystal to a wet surface of the paper during the paper production process to obtain the surface of the facing material with the seed crystal coating.

18. The process for producing a treated facing material for use in gypsum wallboards of claim 8 wherein the adhering of the seed crystal is accomplished through the steps of:
i obtaining a facing material capable of absorbing water;
ii producing a slurry or solution comprising an amount of water and an amount of seed crystal;
iii applying the slurry comprising water and seed crystal to the at least one surface of the facing material to obtain the surface of the facing material with the seed crystal coating.

19. A wallboard comprising:
an interior gypsum plaster core; and
a treated facing material comprising:
a facing material wherein a surface of the facing material is treated with an amount of a seed crystal bonded to the surface of the facing material wherein the seed crystal is selected from the group consisting of CaCO₃, CaSO₄, BaSO₄, Na₂SO₄, KAl(SO₄)₂, CaMg(CO₃)₂, MgCO₃, K₂SO₄, Fe[SO₄]₃/FeSO₄, Al₂[SO₄]₃, and their hydrate forms.
